(19) United States
(12) Patent Application Publication
(10) Pub. No.: US 2023/0029471 A1
(43) Pub. Date: Feb. 2, 2023

(54) CONTENT ORIENTATION ADJUSTMENT

(71) Applicant: Lenovo (United States) Inc., Morrisville, NC (US)

(72) Inventors: Nathan Peterson, Oxford, NC (US); Russell Speight VanBlon, Raleigh, NC (US); Arnold Weksler, Raleigh, NC (US); Mark Delaney, Raleigh, NC (US); John C Mese, Cary, NC (US)

(21) Appl. No.: 17/388,679

(22) Filed: Jul. 29, 2021

(51) Int. Cl. G06T 3/60; G06F 3/01

(52) U.S. Cl. CPC G06T 3/60; G06F 3/013

(57) ABSTRACT

One embodiment provides a method, including: detecting, using an information handling device, signal data of a peripheral device associated with a user; identifying, based on the detecting, a position of the user with respect to the information handling device; determining, using a processor, whether content displayed on the information handling device is oriented toward the position of the user; and adjusting, responsive to determining that the content is not oriented toward the position of the user, an orientation of the content. Other aspects are described and claimed.

### BACKGROUND

Individuals utilize information handling devices (“devices”), for example smart phones, tablet devices, hybrid devices, and the like, to view and interact with displayed content on the device (e.g., text content, multimedia content, etc.). Depending on an interaction context, users may desire to have the displayed content oriented a particular way on the device. For example, users may desire to read long text segments in device portrait mode and view videos and/or other multimedia objects in device landscape mode.

### BRIEF SUMMARY

In summary, one aspect provides a method, including: detecting, using an information handling device, signal data of a peripheral device associated with a user; identifying, based on the detecting, a position of the user with respect to the information handling device; determining, using a processor, whether content displayed on the information handling device is oriented toward the position of the user; and adjusting, responsive to determining that the content is not oriented toward the position of the user, an orientation of the content.

Another aspect provides an information handling device, including: a processor; a memory device that stores instructions executable by the processor to: detect signal data of a proximate device associated with a user; identify, based on the detecting, a position of the user with respect to the information handling device; determine whether content displayed on the information handling device is oriented toward the position of the user; and adjust, responsive to determining that the content is not oriented toward the position of the user, an orientation of the content.

A further aspect provides a product, including: a storage device that stores code, the code being executable by a processor and comprising: code that detects signal data of a peripheral device associated with a user; code that identifies, based on the detecting, a position of the user with respect to an information handling device; code that determines whether content displayed on the information handling device is oriented toward the position of the user; and code that adjusts, responsive to determining that the content is not oriented toward the position of the user, an orientation of the content.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of adjusting an orientation of displayed content to correspond with a user's content viewing position.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally, a user may change the orientation of displayed content on a device by manipulating the orientation of the device. More particularly, most modern devices contain at least one sensor (e.g., a gyroscope, etc.) that may detect an orientation that the device is positioned in and any changes made thereto. When a user tilts a device (e.g., away from them or toward them, etc.) or turns a device (e.g., from portrait mode to landscape mode, etc.) the orientation of content may correspondingly be adjusted. For example, a video originally viewed by a user in portrait mode may automatically expand to fill the screen in landscape mode when a device is turned.

Situations arise where displayed content is not optimally oriented toward a user. For example, when a device is placed down on a flat surface (e.g., a table, etc.), sometimes the display orientation of the screen does not face the user, making it difficult for the user to visualize and/or interact with displayed content. In order to facilitate an orientation correction, a manual user interaction is conventionally required. For instance, a user must pick up the device, manipulate the device position to change the orientation of the displayed screen contents, and then gently set the device back down on the surface to maintain the desired orientation. Such a process may be burdensome and time-consuming. Other existing solutions also exist that may leverage camera sensors to identify a user's position with respect to a device and then adjust the position of the screen contents based upon knowledge of the user's position. However, these solutions lose their value when the camera is not pointed at a user (e.g., when a device is positioned on a flat surface and the camera sensor faces only upward, etc.).

Accordingly, an embodiment provides a method for dynamically adjusting an orientation of displayed content based at least upon positional data associated with user peripheral devices. In an embodiment, signal data from a peripheral device (e.g., a wearable device, a headset, etc.) associated with a user may be detected. An embodiment may then identify a position of the user with respect to the primary device based upon this knowledge and then determine whether content displayed on the primary device is properly oriented toward the user's identified position. If an embodiment determines that it is not, then an adjustment may automatically be made to an orientation of the displayed content. Such a method may ensure that displayed content is always properly oriented toward a user, eliminating the conventional need to manually fix any content orientation issues.

The illustrated example embodiments will be best understood by reference to the figures. The following description is intended only by way of example, and simply illustrates certain example embodiments.

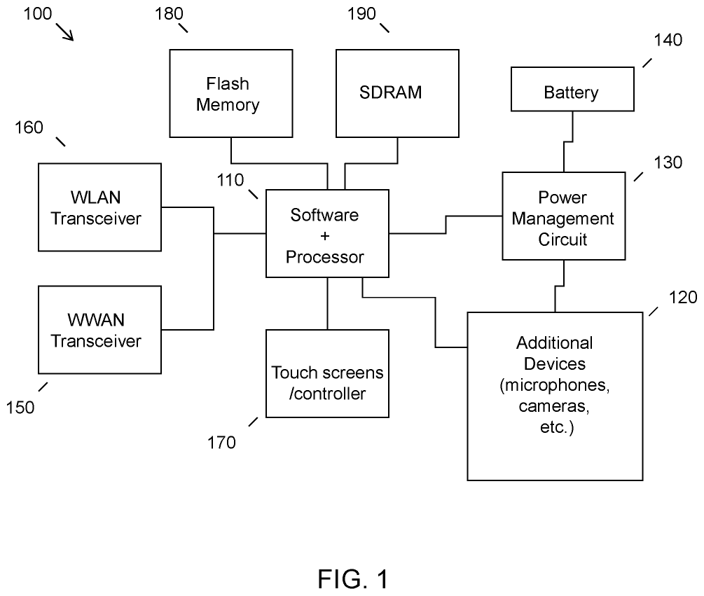

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

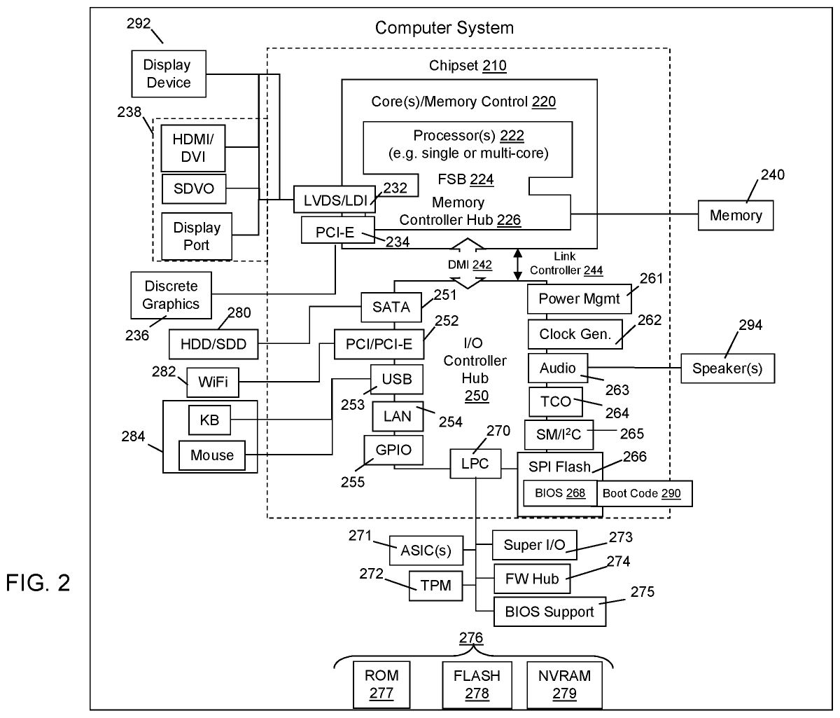

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices that are capable of adjusting the orientation of displayed content. For example, the circuitry outlined in FIG. 1 may be implemented in a smart phone or tablet embodiment, whereas the circuitry outlined in FIG. 2 may be implemented in a hybrid computing device.

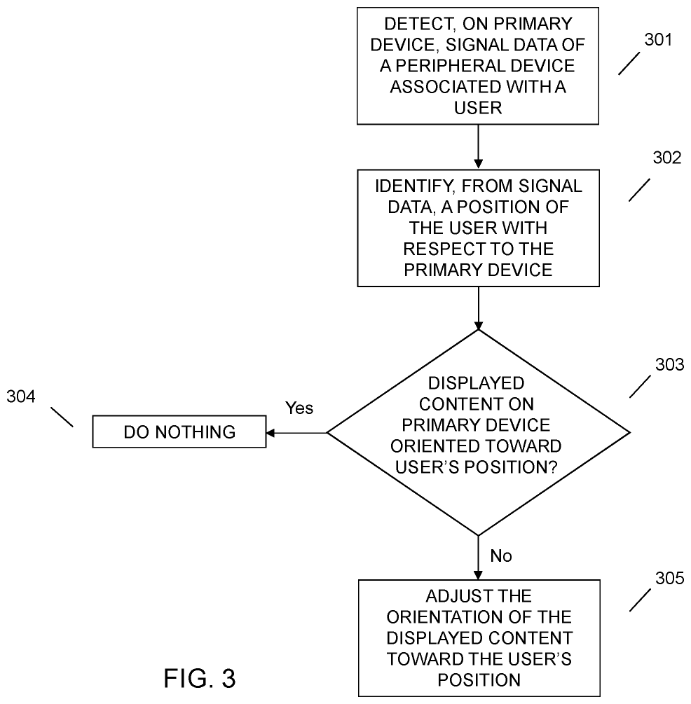

Referring now to FIG. 3, an embodiment provides a method of adjusting an orientation of displayed content. At 301, an embodiment may detect, at a primary computing device (“primary device”), signal data of a peripheral device associated with a user of the primary device. In the context of this application, a peripheral device may be virtually any type of detectable electronic device that a user may wear, carry, or otherwise be proximally associated with. Non-limiting examples of peripheral devices include smart phones, tablets, laptop computers, wearable devices such as smart watches and fitness trackers, head-mounted display devices (“HMD devices”), and the like.

In an embodiment, the signal data may be detected utilizing, for example, ultra-wideband (“UWB”) radio technology. UWB technology corresponds to a short-range, wireless communication protocol that operates at high frequencies (e.g., in a broad spectrum of GHz frequencies, etc.) and can be used to capture highly accurate spatial and directional data. UWB delivers greater accuracy in line-of-site (LoS) and strong localization in non-line-of-sight (nLoS) scenarios and is capable of managing environments in which numerous walls, people and other obstacles would typically block these signals. Additionally, using angle-of-arrival (AoA) technology, the real-time accuracy of UWB measurements provides highly precise device location services at the centimeter level. Furthermore, UWB devices can also determine whether an object is stationary, moving closer, or moving away from a particular point or device. Placing the foregoing in context, UWB technology may be able to: identify the spatial relationship between two devices, identify how one or both devices move with respect to one another, and identify whether one or both devices are moving toward or away from one another.

It is important to note that although the balance of this application discloses the detection of peripheral device signal data utilizing UWB technology, such a designation is not limiting. More particularly, other types of signal-identifying technologies, not explicitly described here, may also be utilized.

At 302, an embodiment may identify a position of the user with respect to the primary device based on the signal data. More particularly, the signal data detected from the peripheral device provides an indication of the distance and/or position of the peripheral device to the primary device. Because the peripheral device is associated with the user's position (e.g., worn by the user, held by the user, proximate to the user in some other way, etc.), then identification of the position of the peripheral device also corresponds to identification of the position of the user with respect to the primary device. In an embodiment, the process to implement identification of the user's position may occur substantially continuously or, alternatively, in response to predetermined events (e.g., at preset time intervals, each time an orientation of the primary device is adjusted, each time a user is detected in the proximate area of the primary device, a combination thereof, and the like.).

To facilitate the identification, an embodiment may differentiate relevant peripheral device signal data associated with a user's position from signal data generated by other types of UWB-enabled devices (e.g., located in the proximate area of the primary device, etc.). Stated differently, an embodiment may identify which detected signals originate from devices associated with a user's position and which detected signals originate from other, non-relevant devices in the user's proximate area. In an embodiment, such a differentiation may be facilitated by accessing a database (e.g., stored locally on the device, stored remotely on another device or server, etc.) that contains indications of the devices that are commonly associated with a user's position based upon various contexts (e.g., a day of the week, a time of day, an activity engaged in by the user, etc.). More particularly, these indications may identify: devices that a user commonly wears (e.g., commonly wears on particular days, commonly wears at particular times of day, commonly wears for particular events, commonly wears around particular people, etc.), devices that a user commonly holds or carries (e.g., commonly holds or carries at particular times or day, commonly holds or carries during certain activities, etc.), or devices that a user is commonly proximate to (e.g., commonly proximate to on certain days, commonly proximate to at a certain time of day, commonly proximate to during a certain activity, etc.). In lieu of the foregoing, once a peripheral device signal is detected, an embodiment may identify (e.g., by reference to the aforementioned database, etc.) whether that detected peripheral device is known to be associated with the user during an existing context. If it is, an embodiment may conclude that the signal data identifying the position of the peripheral device provides an accurate indication of the user's position.

In an embodiment, other types of sensors may provide confirmation of a user's position with respect to the primary device. For example, a primary device may contain one or more camera/video sensors that may be able to capture an image of a proximate area. This captured image may be analyzed (e.g., using one or more conventional image analysis techniques, etc.) to determine if a known user is present in the captured image, and if they are, what their position and/or gaze direction is with respect to the camera sensor, and therefore the primary device. This information may be considered in conjunction with any peripheral device signal data to better confirm the spatial relationship between a user and the primary device.

At 303, an embodiment may determine whether content displayed on the primary device is oriented toward the identified position of the user. In an embodiment, the determination may be facilitated by first identifying a direction that content displayed on the primary device is oriented. Such identification can be made by accessing, inter alia, gyroscopic data and/or other device orientation data to identify an orientation of the device—and correspondingly an orientation of content displayed on the device. An embodiment may then compare the identified direction that displayed content is toward on the device to the identified position of the user.

Responsive to determining, at 303, that the displayed content is oriented in a direction of the user's identified position, an embodiment may, at 304, take no additional action. Conversely, responsive to determining, at 303, that the displayed content is not oriented in a direction of the user's identified position, an embodiment may, at 305, adjust an orientation of the content toward the user's identified position, as further described herein.

In an embodiment, the orientation of the displayed content may be adjusted automatically in response to the determination and without receipt of any additional manual user input. Additionally, the adjustment may occur irrespective of the nature of an existing orientation of the primary device. More particularly, an adjustment to the orientation of the displayed content may occur even if the primary device has a base zero orientation, i.e., is lying flat on a surface.

In an embodiment, the orientation of the displayed content may be adjusted via one or more adjustment types (e.g., a flip adjustment, a turn or rotational adjustment, a slide adjustment, etc.) in virtually any direction (e.g., left, right, up, down, diagonally, etc.). For example, responsive to identifying that an orientation of the displayed content is facing directly away from a user's position, an embodiment may flip the displayed content so that it faces the user's position. In another example, responsive to identifying that an orientation of the displayed content is directed sideways from a user's position, an embodiment may turn the displayed content (e.g., 90 degrees, etc.) so that it faces the user. In yet another example, instances may arise where the primary device contains a long, horizontal display. In these situations, the displayed content may be facing the user's cardinal direction but may also be diagonally offset from the user. An embodiment may therefore slide the displayed content so that it is more directly in line with a user's natural line of sight.

In an embodiment, the adjustment may be instance-based or may be continuous. With respect to the former, responsive to the determination at 303, an embodiment may adjust the orientation of the displayed content a single time so that it aligns with a user's identified position. With respect to the latter, an embodiment may continuously identify a user's position with respect to the primary device and thereafter continuously adjust the oriented of displayed content if necessary. As a non-limiting example of the foregoing, a user may be walking around a primary device (e.g., in a circle, etc.). As the user moves around the primary device, the displayed content is substantially continuously and fluidly adjusted to “move” with the user (e.g., the displayed content may circle around the screen to match a user's movement around the primary device, etc.).

The various embodiments described herein thus represent a technical improvement to conventional methods for adjusting an orientation of displayed content. Using the techniques described herein, an embodiment may detect signal data of a peripheral device associated with a user. An embodiment may then identify, from this signal data, a corresponding position of the user with respect to a primary device and determine whether content displayed on that primary device is oriented toward the user's position. Responsive to determining that it is not, an embodiment may dynamically adjust an orientation of the displayed content to better align with the user's position. Such a method may ensure that displayed content is always correctly oriented toward a user.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
detecting, using an information handling device, signal data of a peripheral device associated with a user;
identifying, based on the detecting, a position of the user with respect to the information handling device, wherein the position of the user comprises directional data;
determining, using a processor, whether content displayed on the information handling device is oriented toward the position of the user; and
adjusting, responsive to determining that the content is not oriented toward the position of the user, an orientation of the content toward the identified position of the user.

2. The method of claim 1, wherein the detecting comprising detecting the signal data of the peripheral device utilizing an ultra-wideband wireless communication protocol.

3. The method of claim 1, wherein the detecting comprises differentiating the signal data of the peripheral device associated with the user from other signal data types of non-user affiliated peripheral devices.

4. The method of claim 1, wherein the peripheral device is selected from the group consisting of a wearable device and another type of information handling device.

5. The method of claim 1, wherein the determining comprises:
identifying, using content orientation data, an original orientation of the content;
comparing the original orientation of the content with the position of the user; and
determining whether the position of the user is aligned with the original orientation of the content.

6. The method of claim 1, wherein the adjusting the orientation of the content comprises adjusting via an adjustment type selected from the group consisting of: a flip adjustment, a turn adjustment, and a slide adjustment.

7. The method of claim 1, wherein the adjusting the orientation of the content comprises adjusting the orientation without detecting an orientation change of the information handling device.

8. The method of claim 1, wherein the identifying comprising continually identifying the position of the user and wherein the adjusting comprises continually adjusting the orientation of the content.

9. The method of claim 8, wherein the continually adjusting comprises adjusting the orientation of the content in an uninterrupted motion.

10. The method of claim 1, wherein the identifying the position of the user further comprises capturing, using a camera sensor of the information handling device, an image of the user and wherein the determining further comprises:
identifying, via analysis of the image, a gaze direction of the user; and
determining whether the gaze direction corresponds to the orientation of the device position of the information handling device.

11. An information handling device, comprising:
a processor;
a memory device that stores instructions executable by the processor to:
detect signal data of a peripheral device associated with a user;
identify, based on the detecting, a position of the user with respect to the information handling device, wherein the position of the user comprises directional data;
determine whether content displayed on the information handling device is oriented toward the position of the user; and
adjust, responsive to determining that the content is not oriented toward the position of the user, an orientation of the content toward the identified position of the user.

12. The information handling device of claim 11, wherein the instructions executable by the processor to detect comprise instructions executable by the processor to detect the signal data of the peripheral device utilizing an ultra-wideband wireless communication protocol.

13. The information handling device of claim 11, wherein the instructions executable by the processor to detect comprise instructions executable by the processor to differentiate the signal data of the peripheral device associated with the user from other signal data types of non-user affiliated peripheral devices.

14. The information handling device of claim 11, wherein the peripheral device is selected from the group consisting of a wearable device, a headset, and another type of information handling device.

15. The information handling device of claim 11, wherein the instructions executable by the processor to determine comprise instructions executable by the processor to:
identify, using content orientation data, an original orientation of the content;
compare the original orientation of the content with the position of the user; and
determine whether the position of the user is aligned with the original orientation of the content.

16. The information handling device of claim 11, wherein the instructions executable by the processor to adjust the orientation of the content comprise instructions executable by the processor to adjust via an adjustment type selected from the group consisting of: a flip adjustment, a turn adjustment, and a slide adjustment.

17. The information handling device of claim 11, wherein the instructions executable by the processor to identify comprise instructions executable by the processor to continually identify the position of the user and wherein the instructions executable by the processor to adjust comprise instructions executable by the processor to continually adjust the orientation of the content.

18. The information handling device of claim 17, wherein the instructions executable by the processor to continually adjust comprise instructions executable by the processor to adjust the orientation of the content in an uninterrupted motion.

19. The information handling device of claim 11, wherein the instructions executable by the processor to identify the position of the user further comprise instructions executable by the processor to capture, using a camera sensor of the information handling device, an image of the user and wherein the instructions executable by the processor to determine further comprise instructions executable by the processor to:
identify, via analysis of the image, a gaze direction of the user; and
determine whether the gaze direction corresponds to the orientation of the device position of the information handling device.

20. A product, comprising:
a non-transitory storage device that stores code, the code being executable by a processor and comprising:
code that detects signal data of a peripheral device associated with a user;
code that identifies, based on the detecting, a position of the user with respect to an information handling device, wherein the position of the user comprises directional data;
code that determines whether content displayed on the information handling device is oriented toward the position of the user; and
code that adjusts, responsive to determining that the content is not oriented toward the position of the user, an orientation of the content toward the identified position of the user.
